(19) United States
(12) Patent Application Publication
(10) Pub. No.: US 2013/0183414 A1
(43) Pub. Date: Jul. 18, 2013

(54) EDIBLE FOOD WRAP AND METHOD FOR MAKING SAME

(71) Applicants: SUNG YONG SONG, Little Ferry, NJ (US); NANA SONG, Little Falls, NJ (US)

(72) Inventors: SUNG YONG SONG, Little Ferry, NJ (US); NANA SONG, Little Falls, NJ (US)

(21) Appl. No.: 13/349,030

(22) Filed: Jan. 12, 2012

(51) Int. Cl. A23L 1/212

(52) U.S. Cl. 426/138; 426/262

(57) ABSTRACT

An edible food wrap for a variety of comestible is described. A peeling device is employed to produce a thin, elongated strip of a suitable edible material. The precisely cut strip can then be efficiently and completely deodorized and decolorized by soaking in a PH controlled alkaline water solution. Adding color to the strip is done preferentially with naturally occurring colors added directly to the alkaline water solution. White vinegar added at this time protects the intensity of the color added to the strip. The food wrap is then ready for use, particularly well suited for the outer covering of sushi.

This invention relates to a food preparation device. More particularly the invention relates to a manually operated device adapted for the preparation of sushi or the like.

### BACKGROUND OF THE INVENTION

Sushi is a Japanese food with over a thousand years of history and tradition. It has become the most visible example of Japanese cuisine in New Zealand and other Western Countries.

Sushi began as a way of preserving fish. The raw, cleaned fish was pressed between rice and salt by a heavy stone for a few weeks. After this period, the stone was removed and replaced with a light cover. A few months after that, the fermented fish and rice were considered ready to eat.

It was not until the 18^{th} Century that a chef by the name of Yohei decided to serve sushi in its present form. He eliminated the fermentation process altogether. It is said that the use of rice wine vinegar is reminiscent of the earlier fermentation tradition.

Sushi comes in at least three forms. An Osaka variation, which is probably the more elaborate form, is prepared traditionally by pressing rice in wooden bowls. The more familiar form of sushi to westerners comes from Edo, the old name for Tokyo, and consists of hand-rolled rice. This particular style is called nigiri sushi.

Maki sushi is the form of sushi most familiar to us. Maki sushi is “rolled sushi” with narrow strips of different ingredients (seafood, meat, chicken, crisp vegetables, or pickles) layered on a bed of vinegar rice and spread on a sheet of nori or seaweed. This form of sushi is very popular because it can be tailored to suit a variety of tastes where just about any ingredient can be rolled into the center from crisp vegetables, strips of fish, meat, chicken, egg or even avocado.

Although sushi is now very popular with Europeans, no easy way has been devised to make what is essentially a very simple product. Sushi is after all just strips of fish, or even meat rolled in rice and wrapped in crisp, thin sheet of dried seaweed or nori. The filing generally also contains wasabe (Japanese horseradish), usually as a paste, although this is not necessary.

Maki are thin sheets of seaweed, which will be referred hereinafter to as nori. The nori is topped with a layer of vinegared boiled rice, which once produced, is filled with pieces of fish, omelet, vegetables or other traditional food items. The nori, rice, and filling are then traditionally rolled by hand into a cylindrical tube and then pressed by hand with a bamboo mat so as to tighten and consolidate the nori, rice, and fillings. The maki is than sliced into pieces and served.

As intimated earlier although sushi is a simple dish it is extra-ordinarily difficult and messy to prepare. There has been a long felt need to be able to prepare sushi quickly, with a minimum of mess and with consistent size and texture. Additionally an attractive, nutritious edible food wrap can be of great importance to virtually any comestible product.

Obviously the patent literature notes many attempts at solving some of these problems. For example, U.S. Pat. No. 6,500,473 B1 discloses a “Coloring Substance Composition And A Method Of Manufacturing Same”. The patent notes using beef pectin, chicory pectin or Jerusalem artichoke pectin as wetting and/or dispersing agents when combined with a suitable coloring agent. The method can be used to manufacture edible films for containing a food product such as a meat product or a vegetable product (col. 8, lines 63-66). Again, U.S. Pat. No. 5,480,788 discloses “Bleaching of Plant Materials”. The patent teaches soaking a plant material including peels and skins (col. 1, lines 19-24) in a aqueous solution containing an alkaline agent and more than 100 g/l of hydrogen peroxide, and having a PH of at least 8.5 in order to bleach the plant materials.

U.S. Pat. No. 4,115,595 discloses a “Process For Coloring Maraschino Cherries With Natural Colors”. The patent teaches coloring maraschino cherries at a PH below 7 and under vacuum. Beets are discussed as a coloring agent at Col. 2, lines 58-68, Col. 3, lines 1-2. Also example 2 at Col. 7 discuses beet juice for coloring sliced cucumber.

J.P. 63-126452 (A) discloses “Cherry And Japanese Radish Preserved in Sweet Vinegar”. The patent teaches sugar treated cherries being wrapped with thin cut Japanese radish, then being served as an hors d'oeuvre.

J.P. 3-065134 (A) discloses “Preparation of Pickles”. The patent teaches Japanese radish, turnip, or cabbage being cut, peeled and pickled in salt prior to being colored by mixing with the juice of red grapes.

J.P. 2001-333749 (A) discloses “Chinese Meat Dumpling Using Pastry Of Thin Piece Of Radish”. The patent teaches thinly peeling a radish, immersing it in a saline solution, sprinkling it with wheat flower, forming it into a pouch, and then filing the pouch with a meat dumpling.

While the above noted documents describe useful solutions for a variety of food coloring and wrapping problems, they do not envision the economy, convenience and uniquely attractive food wrap appearance disclosed in the present invention.

Accordingly a primary object of the present invention is to provide an edible food wrap for a variety of comestibles.

A further object of the invention is to provide a method for slicing a food for subsequent use as a food wrap for uniform presentation of individual food portions wrapped therein.

An additional object is to provide for efficient, complete decolorization and deodorization of sliced food for subsequent use as a food wrap.

Still another object is to provide for in depth coloring of the above noted decolorized and deodorized food slices using naturally occurring coloring agents.

Yet another object of the invention is to provide an edible food wrap for the efficient, economical, and aesthetically attractive preparation of individual sushi portion in a form familiar to both Japanese and European customers.

### SUMMARY OF THE INVENTION

The above objects and others are obtained with the edible food wrap and method of making same of the present invention.

As noted above putting together sushi, including the familiar maki sushi, is a complicated and difficult procedure. It occurred that simplifying and standardizing the wrap for the remainder of the sushi ingredients would significantly ease routine sushi preparation. A variety of fruits and vegetable can also serve as a food wrap if properly prepared as suitable thin slices. Obviously slicing by hand would not produce suitably standard results. To this end an investigation of peeling devices uncovered the Vegg-Q (available from JC UNI-TEC, 1467 W. 178^{th} Street, Suite 301, Gardena, Calif. 90248), which was found particularly well suited to this application. For example, radishes and cucumbers could be efficiently thin sliced in thicknesses between 1 mm to 0.25 mm, in lengths between 2″ to 4 feet and in widths between 1″ to 10″. These thin slices could then be folded in a serpentine manner and placed within an appropriate container for further processing.

The next step in a food wrap preparation would be to decolorize and deodorize the thin slices. A first attempt put the thin slices in a mild alkaline solution of sodium bicarbonate in water, with a PH between 7.5 to 8.5, for a period of time, e.g. 24 hours, producing satisfactory results. Further experiments using ionized water produced more efficient and noticeably superior results. In the preferred method alkaline ionized water, produced by the IONIZER BHL-3100 (available from Alkazone, 200 South Newman Street, Hackensack, N.J. 07601), is sprayed onto the slices in the container until they are fully submerged. The ionizer device can be set for a PH range between 7.5 to 10.

Finally, for those application where a noticeably colored food wrap is required, a coloring agent is added directly to the ionized water bath containing the sliced food wrap. Depending on producer preferences the coloring agent can be selected from FDA approved agents. However, from a purist point of view only naturally occurring coloring substances should be used. In this latter case materials such as red colored beets or yellow colored beets are sliced and placed directly in the ionized water bath containing the thin food wrap slices for a period of time, which can vary from as little as five minutes to 24 hours, with a 12 hour time period considered optimal Importantly, it has been found that when vinegar is added directly to the ionized water bath, at the beginning of the color soaking procedure, that it be restricted to white vinegar to preserve a more intensely colored food wrap.

The results of the above food wrap preparation method are an efficient and economically produced uniform material in color and texture ideally suited for an attractive and nutritious sushi dish. In addition to the above noted radish and cucumber many other vegetables and fruits can be employed, including lotus root, apple, onion, and so on. Further, the method of the present invention can be used for a variety of food wraps where attractive uniformity is important.

### BRIEF DESCRIPTION OF THE DRAWINGS

FIG. 1 is a flow chart describing the steps involved in the production of the edible food wrap of the invention.

FIG. 2 is a perspective view depicting a typical radish prior to processing as an edible food wrap.

FIG. 3 is a perspective view illustrating a radish positioned within a peeling device being processed as an edible food wrap.

FIG. 4 depicts the radish of FIG. 2 as having been peeled and serpentine folded for further processing.

FIG. 5 is a top plan view illustrating the peeled and folded radish of FIG. 4 now positioned within a container and being spray immersed in an alkaline water solution supplied by a water ionizing device.

FIG. 6 is a top plan view depicting a coloring agent, such as red beets, being added to the container depicted in FIG. 5.

FIG. 7 illustrates one possible finished product of the invention as a lavender-violet colored, thin sliced and folded section of radish now ready for use as an edible food wrap.

FIG. 8 is a side, elevational view of the version of the invention illustrated in FIG. 7 as being packed and ready for sale.

FIG. 9 is a perspective view of the version of the invention depicted in FIGS. 7 and 8 now being employed as a food wrap for a typical bar of sushi.

### DETAILED DESCRIPTION OF THE PREFERRED EMBODIMENTS

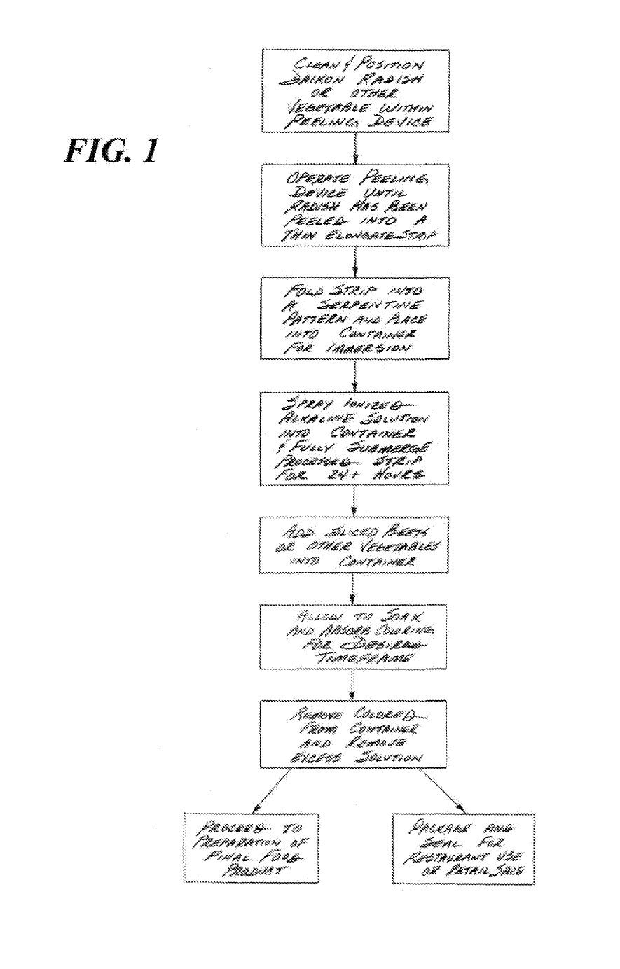

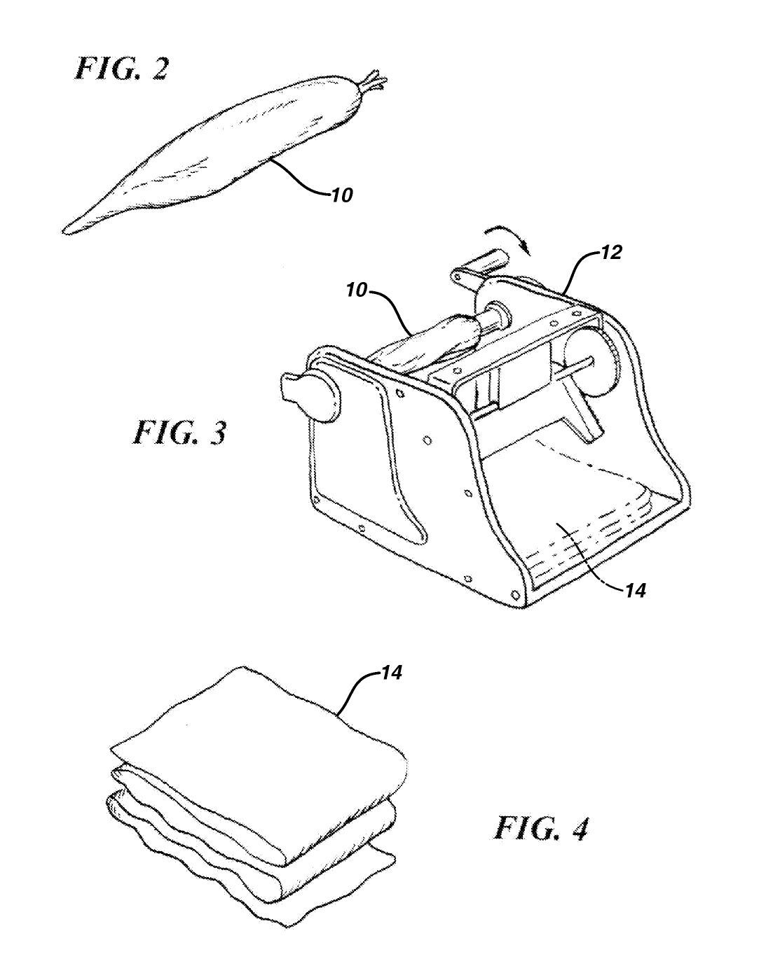

Turning now to the drawings wherein similar items having the same function are denoted with the same numerals in FIG. 1 a flow chart details the steps involved in one version of the process of the present invention. FIG. 2 depicts a typical radish 10 having been cleaned and prepared for slicing. In FIG. 3 the radish 10 is shown positioned within a vegetable peeling device 12, and having been substantially thin sliced 14. As best seen in FIG. 4 the radish 14 is thin sliced in an elongated, serpentine manner Typical dimensions obtained are 1 mm-0.25 mm in thickness, 2″ to 4 feet in length, and a width measuring between 1″ to 10″. While the vegetable can be sliced in a number of ways, including hand slicing, it has been found that the Vegg-Q peeler, available from J.C. UNI-TEC, Inc., 167 W. 178^{th} Street, Suite 301, Gardena, Calif. 90248, is particularly well suited to this application.

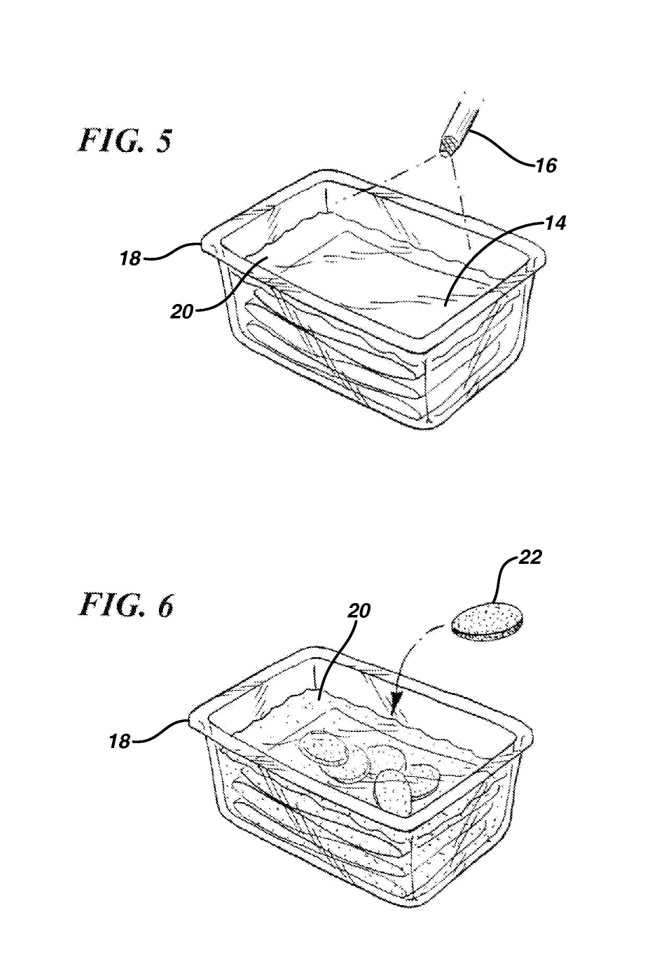

In FIG. 5 the important step of decolorizing and deodorizing the thin sliced radish (vegetable) is illustrated. The serpentine thin sliced strip 14 of radish 10 is shown positioned within an approximate 4 quart container and then being submerged approximately 2 quarts of an alkaline water bath 20 for a suitable period of time, e.g. 24 hours. The alkaline water bath can be prepared in a number of ways, as, for example, adding sodium bicarbonate to obtain a PH of between 7.5 and 8.5. Superior results have been obtained by first placing the sliced strips 14 in the container 18, and then spraying the strips with an alkaline water generated by a water ionizing device such as the Alkazone Ionizer BHL-3100, (available from Alkazone, 200 South Newman Street, Hackensack, N.J. 07601). The device is capable of producing alkaline water with a PH between 7.0 to 10.0, with a range between 7.5 to 9.0 being found to yield noticeably more efficient and thorough results.

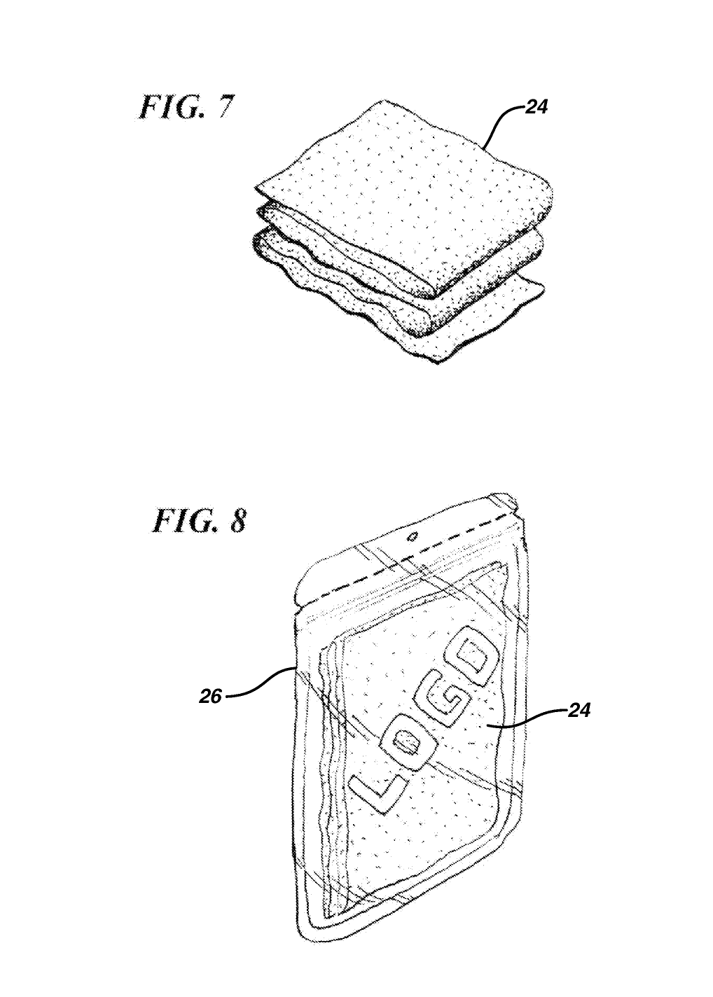

When required as shown in FIG. 6, the final step of coloring the thin sliced strip of radish (vegetable) can be performed in the container 18 and alkaline water 20 employed in the decolorization and the deodorization procedure of FIG. 5. A variety of colors and coloring methods can be used, including FDA approved colors. From a purist point of view only naturally occurring colors should be employed. To that end, red beets 22 are shown having been sliced and added directly to the alkaline water 20 within the container 18. The strip in the container is permitted to soak up the color of the beets, in this case a lavender-purple color, for a period of time. The period of time can be as little as 5 minutes to as much as 24 hours, with 12 hours considered optimal. The result of this procedure is shown in FIG. 7 with the sliced strip 14 of FIG. 4 now shown with a lavender-purple color 24.

FIG. 8 illustrates a possible commercial end product of the invention in which the sliced and colored strip 24 is now displayed ready for use in clear plastic package 26.

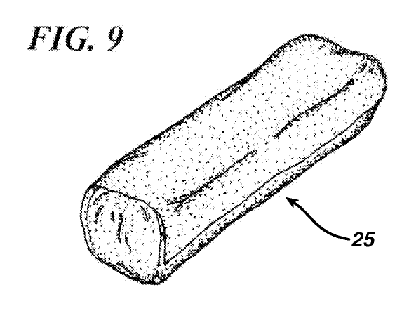

Finally, in FIG. 9 the sliced and colored strip is shown attractively and invitingly covering a bar of sushi 25.

The following examples are intended to point out the new efficiencies obtained with the edible food wrap process described above.

### Example 1

A typical white radish of approximately 300 gms. is cleaned and positioned within the Vegg-Q peeling device. The device is set to deliver 4″ wide slices at a thickness of approximately 1.5 mm. The radish is processed yielding about 4 feet of product which is then folded in a serpentine pattern and placed within a four quart container. Ionized water at a PH of 7.5, supplied by the Alkazone Ionizer BHL-3100, is sprayed onto the radish strip within the container, completely covering the strip with about 2 quarts of the ionized water. At this time approximately 150 ml of white vinegar and 3 Tbsp of salt are added to the alkaline water. The strip is permitted to soak in the container for approximately 24 hours.

In this case a lavender-purple color was desired, supplied by slicing a 200 gm. red colored beet, and adding the slices directly to the strip within the container. The strip is allowed to soak up the color for a period of 6 hours.

Finally the now lavender-purple colored strip is removed from the container and drained of excess fluid, now ready for immediate use or packaging for future food wrapping procedures.

### Example 2

A 300 gm green cucumber is cleaned and positioned within the Vegg-Q peeling device. The device is set to cut the cucumber at a width set at 3″ and a 2.0 mm thickness. The cutting process produces about 4 feet of product which is then folded in a serpentine pattern and placed within a 4 quart container. Approximately 2 quarts of ionized water at a PH of 8.5, supplied by the Alkazone Ionizer BHL-3100, is sprayed over the strip within the container. At this time 150 ml of white vinegar and 3 Tbsp of salt are added to the alkaline water. The strip is allowed to deodorize and decolorize in the ionized alkaline water for about 24 hours.

To produce a bright yellow color, a 200 gm yellow beet is sliced and added to the strip in the ionized alkaline water. The strip is allowed to soak in this final mixture for 12 hours.

Finally the now brightly yellow colored strip is removed from the container and drained of excess fluid, now ready for use as a food wrap.

While the present invention has been disclosed in connection with versions shown in detail, various modifications and improvements will become readily apparent to those skilled in the art. Accordingly, the spirit and scope of the present invention is to be limited only by the following claims.

What is claimed is:

1. A process for making an edible food wrap for a variety of comestibles, said process comprising:
(a) cleaning and positioning a food item within a peeling device;
(b) operating said peeling device until said food item has been peeled into a thin, elongated strip;
(c) folding said strip in a substantially serpentine pattern, and placing said strip within a container having sufficient depth for complete immersion of said strip;
(d) adding an alkaline water solution into said container until said strip is fully submerged in said alkaline water;
(e) maintaining said strip within said alkaline water for a period of time;
(f) adding a coloring agent to said alkaline water;
(g) permitting said strip to soak in and absorb said coloring agent over a period of time; and
(h) removing said strip from said container and draining excess fluid from said strip.

2. An edible food wrap make in accordance with the process of claim 1.

3. The process for making an edible food wrap according to claim 1 wherein said step of operating said peeling device produces said elongated strip in a thickness between approximately 1 mm and 0.25 mm.

4. The process for forming an edible food wrap according to claim 1 wherein an approximate PH range between 7.5 and 9 is maintained in said alkaline water solution during said step of immersing said strip in said alkaline water solution within said container.

5. The process for forming an edible food wrap according to claim 4 wherein said alkaline water solution added to said container to submerge said strip therein is produced by an ionized water producing device.

6. The process for forming an edible food wrap according to claim 1 wherein a naturally occurring coloring agent is employed during said step of adding a coloring agent to said alkaline water solution.

7. The process for forming an edible food wrap according to claim 1 further including the step of adding a quantity of white vinegar to said alkaline water solution within said container during said step of adding a coloring agent to said alkaline water solution.

8. The process for forming an edible food wrap according to claim 1 wherein said food wrap when processed is employed as an outer covering for sushi.

9. A process for making an edible food wrap for a variety of comestibles, said process comprising:
(a) cleaning and positioning a food item within a peeling device;
(b) operating said peeling device until said food item has been peeled into a thin, elongated strip measuring approximately 1 mm to 0.25 mm in thickness;
(c) folding said strip in a substantially serpentine pattern, and placing said strip within a container having sufficient depth for complete immersion of said strip;
(d) adding an ionized alkaline water solution ,made by an ionized water producing device, into said container until said strip within said container is fully submerged in said ionized alkaline water solution, said ionized alkaline water solution being maintained at an approximate PH range between 7.5 and 9.0;
(e) maintaining said strip within said ionized alkaline water solution for a period of time;
(f) adding a naturally occurring coloring agent to said ionized alkaline water solution;
(g) permitting said strip to soak in and absorb said naturally occurring coloring agent over a period of time; and
(h) removing said strip from said container and draining excess fluid from said strip.

10. The process or making an edible food wrap according to claim 9 further including the step of adding a quantity of white vinegar to said ionized alkaline water solution within said container during said step of adding a naturally occurring coloring agent to said ionized alkaline water solution.

11. An edible food wrap made according to the process of claim 9.
